(19) United States
(12) Patent Application Publication
(10) Pub. No.: US 2002/0141411 A1
(43) Pub. Date: Oct. 3, 2002

(54) Apparatus for line-concentrating and distributing PPP frame data

(76) Inventor: Jong-Hwan Oh, Seo-Gu (KR)

Correspondence Address: BACON & THOMAS, PLLC, 4th Floor, 625 Slaters Lane, Alexandria, VA, 22314-1176, US

(21) Appl. No.: 09/824,104

(22) Filed: Apr. 3, 2001

(51) Int. Cl. H04L 12/56

(52) U.S. Cl. 370/392; 370/469

(57) ABSTRACT

An apparatus transmits bit-synchronized PPP frame data between N numbers of subhighways (SHWs), embodied in an access switch subsystem of a switch, and a message switch module (MSM), embodied in an Internet gateway unit implemented for switching between Internet and the switch. The apparatus comprises a line-concentrating unit for extracting and storing valid bit-synchronized PPP frame data based on the bit-synchronized PPP frame data provided thereto on time slot basis, sequentially reading out the stored valid bit-synchronized PPP frame data to thereby produce line-concentrated PPP frame data to the MSM, and a distributing unit for extracting valid PPP frame data from the line-concentrated PPP frame data, sequentially storing the extracted valid PPP frame data, concurrently reading out the stored valid PPP frame data on time slot basis and transferring the read-out valid PPP frame data through a corresponding time slot of a pertinent SHW.

### FIELD OF THE INVENTION

The present invention relates to an Internet gateway unit for interfacing between a switch and Internet; and more particularly, to an apparatus for line-concentrating and distributing point-to-point protocol (PPP) frame data which are transmitted between a subhighway (SHW) capable of transmitting PPP frame data bit-synchronized in an access switch subsystem (ASS) and a message switch module (MSM) to be embodied in the Internet gateway unit.

### BACKGROUND OF THE INVENTION

As well known, Internet is a huge communications network capable of connecting all local communications networks in the world based on a transmission control protocol/Internet protocol (TCP/IP). When an arbitrary subscriber tries to have access to the Internet, the access to the Internet is attempted necessarily via a corresponding switch in an existing communications environment.

However, an existing switch is configured to allocate internal switches and link resources in a same manner without considering whether a requested call is an Internet call or an ordinary call. Thereafter, as the number of Internet calls increases, the quality of a call processing service of the switch is deteriorated since the Internet call usually maintains a longer connection state than the ordinary call. That is, as the number of Internet calls increases, the number of calls occupying the internal switches and link resources of the switch for a long time also increases, so that there may frequently occur a situation in which a service related to a request for a set-up of a new call is not effectively performed.

In order to overcome the above drawback, recently, a new Internet gateway unit has been developed. This new Internet gateway unit will be installed inside or outside of an access switch subsystem (ASS) embodied in the switch so as to make access to Internet while minimizing the occupation of the internal switches and link resources in the switch if the desired call is the Internet call. Further, the Internet gateway unit will employ therein a message switch module (MSM) for performing a high-speed real-time routing for point-to-point protocol (PPP) frame data provided thereto.

However, although the ASS includes a plurality of subhighways (SHWs) capable of transmitting bit-synchronized PPP frame data and each SHW has thereon a multiplicity of channels, e.g., 32 or 64 channels, capable of transmitting the bit-synchronized PPP frame data, all of the channels do not always transmit the bit-synchronized PPP frame data. That is to say, there may exist idle channels through which the bit-synchronized PPP frame data are not transmitted because the bit-synchronized PPP frame data are based on a high-level data link control (HDLC) format which is transmitted through only one channel on an SHW allocated when an Internet call is generated.

Therefore, for maximizing the high-speed real-time routing performance of the MSM, it is required to develop an apparatus capable of line-concentrating and distributing PPP frame data transmitted between the SHW and the MSM.

### SUMMARY OF THE INVENTION

It is, therefore, a primary object of the present invention to provide an apparatus for line-concentrating and distributing PPP frame data which are transmitted between a subhighway capable of transmitting bit-synchronized PPP frame data and a message switch module which can perform a high-speed real-time routing and is embodied in an Internet gateway unit.

In accordance with the present invention, there is provided an apparatus for transmitting bit-synchronized PPP frame data between N numbers of subhighways (SHWs), N being a predetermined integer, which are embodied in an access switch subsystem of a switch and are capable of transmitting the bit-synchronized PPP frame data that have a high-level data link control (HDLC) format and are generated to process Internet calls, and a message switch module (MSM), embodied in an Internet gateway unit implemented for switching between Internet and the switch, for routing and transmitting the bit-synchronized PPP frame data, which comprises:

a line-concentrating unit for, if the bit-synchronized PPP frame data are provided through M numbers of time slots included in each of the subhighways, M being a predetermined integer, extracting and storing valid bit-synchronized PPP frame data on time slot basis, sequentially reading out the stored valid bit-synchronized PPP frame data to thereby produce line-concentrated PPP frame data, and transmitting the line-concentrated PPP frame data to the MSM; and

a distributing unit for, if the line-concentrated PPP frame data are provided from the MSM, extracting valid PPP frame data, sequentially storing the extracted valid PPP frame data, concurrently reading out the stored valid PPP frame data on time slot basis and transferring the read-out valid PPP frame data through a corresponding time slot of a pertinent subhighway.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a block diagram of an apparatus for line-concentrating and distributing PPP frame data in accordance with the present invention;

FIG. 2 is a detailed block diagram of the PPP frame data line-concentrating unit 110 in FIG. 1;

FIG. 3 shows a structure of PPP frame data based on an HDLC format;

FIG. 4 provides a detailed block diagram of the first memory buffering unit 210 in FIG. 2;

FIG. 5 describes a detailed block diagram of the data converting unit 230 in FIG. 2;

FIG. 6 represents a detailed block diagram of the frame generator 507 in FIG. 5;

FIG. 7 depicts a structure of converted PPP frame data outputted from the frame generator 507 in FIG. 6;

FIG. 8 illustrates a detailed block diagram of the PPP frame data distributing unit 120 in FIG. 1;

FIG. 9 shows a detailed block diagram of the frame generator 830 in FIG. 8; and

FIG. 10 provides a detailed block diagram of the second memory buffering unit 840 in FIG. 8.

### DETAILED DESCRIPTION OF THE PREFERRED EMBODIMENTS

While referring to the drawings, the preferred embodiments of the present invention will now be explained in detail.

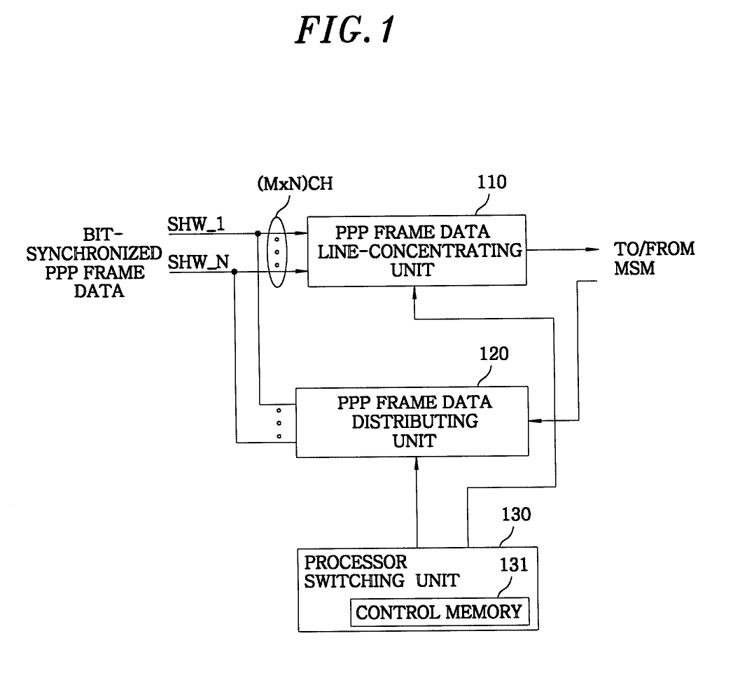

Referring to FIG. 1, there is illustrated a block diagram of an apparatus for line-concentrating and distributing PPP frame data in accordance with the present invention, which comprises a PPP frame data line-concentrating unit 110, a PPP frame data distributing unit 120 and a processor switching unit 130.

The PPP frame data line-concentrating unit 110 line-concentrates bit-synchronized PPP frame data which are generated in order to process Internet calls and then provided to the unit 110 through N numbers of subhighways SHW_1 to SHW_N, N being a predetermined integer, thereby providing line-concentrated PPP frame data to a message switch module (MSM) (not shown).

The PPP frame data distributing unit 120 distributes PPP frame data transferred from the MSM and provides distributed PPP frame data onto channels of the subhighways.

The processor switching unit 130 stores routing information supplied from a higher processor (not shown), provides the PPP frame data line-concentrating unit 110 with routing information which will be inserted on a PPP frame basis, and supplies the PPP frame data distributing unit 120 with information which will be used in verifying whether the received PPP frame is a receivable frame or not.

Further, the processor switching unit 130 includes a control memory 131 for storing the information provided from the higher processor so as to perform the above-mentioned functions thereof. The higher processor can be an access switching processor for performing operation & maintenance and a call flow control in an access switching subsystem.

The operation of the PPP frame data line-concentrating and distributing apparatus in FIG. 1 will be described hereinbelow.

First of all, the PPP is a protocol used to transmitting TCP/IP information through a serial line such as a telephone line and the PPP frame data is a PPP frame data transmitted according to the PPP, which is based on a high-level data link control (HDLC) format. Therefore, the bit-synchronized PPP frame data are also PPP frame data having the HDLC format and transmitted on a bit-by-bit basis.

The N numbers of subhighways SHW_1 to SHW_N are connected to an access basic subscriber interface (ABSI) (not shown) or a time switch & link (not shown) embodied in the access switching subsystem of the switch, thereby transmitting PPP frame data, which are generated by channels as an Internet call is set up, in a bit-synchronized form.

The PPP frame data line-concentrating unit 110 is connected to the N numbers of subhighways SHW_1 to SHW_N to thereby line-concentrate the bit-synchronized PPP frame data provided by channels, converts the line-concentrated PPP frame data on a frame basis, and provides the converted PPP frame data to the MSM (not shown). Then, the converted PPP frame data are self-routed at the MSM.

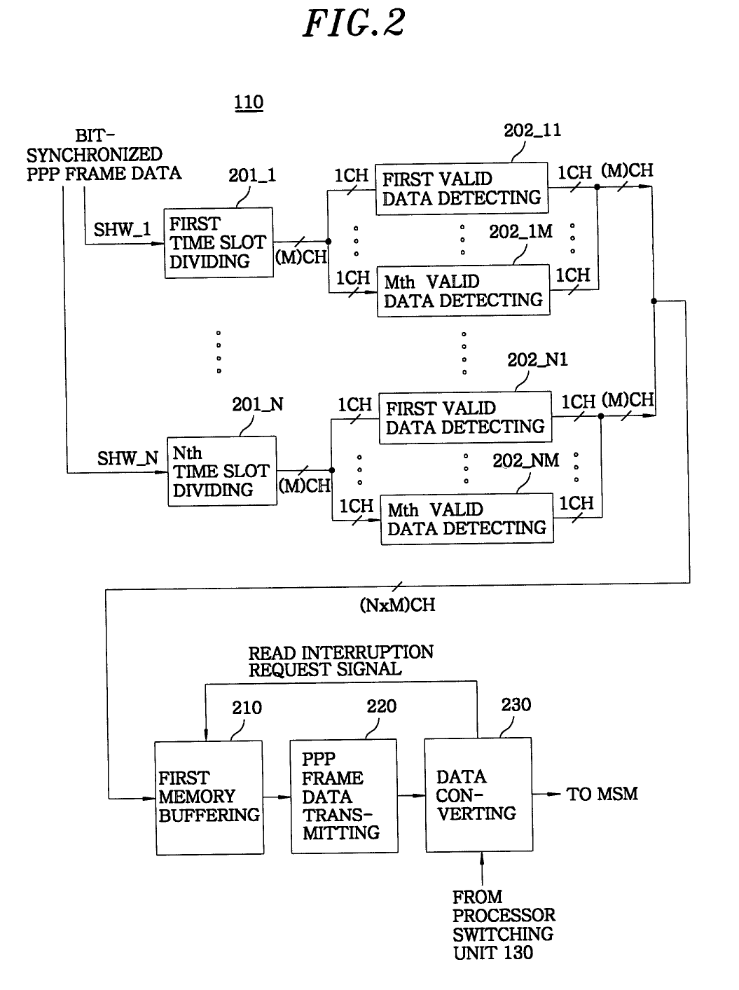

Referring to FIG. 2, there is described a block diagram of the PPP frame data line-concentrating unit 110 shown in FIG. 1.

The PPP frame data line-concentrating unit 110 includes a first to an Nth time slot dividing unit, namely, 201_1 to 201_N, which are connected to the N numbers of subhighways SHW_1 to SHW_N, respectively, M numbers of valid data detecting units 202_{—}k1 to 202_{—}kM, M being a predetermined integer, connected to each of the N numbers of time slot dividing units 201_1 to 201_N, which detect whether or not valid PPP frame data are transmitted on time slot basis, k being 1 to N, a first memory buffering unit 210 for storing valid PPP frame data fed thereto on time slot basis from the M numbers of valid data detecting units 202_{—}k1 to 202_{—}kM and sequentially reading out and outputting the stored PPP frame data, a PPP frame data transmitting unit 220 for transmitting the PPP frame data, supplied from the first memory buffering unit 210, in a form of high-speed serial data, and a data converting unit 230 for converting the PPP frame data provided from the PPP frame data transmitting unit 220 into a data form including information capable of being self-routed at the MSM, and outputting the converted PPP data. The self-routable information used in the data converting unit 230 is provided from the processor switching unit 130.

The first time slot dividing unit 201_1 connected to the first subhighway SHW_1 divides the bit-synchronized PPP frame data transmitted through the first subhighway SHW_1 on time slot basis. In FIG. 2, there are shown M numbers of time slots (M CH) for each subhighway. Accordingly, the first time slot dividing unit 201_1 separates the data transmitted via the first subhighway SHW_1 into M sets of bit-synchronized PPP frame data that are then transferred via respective transmission channels. In the meantime, the Nth time slot dividing unit 201_N is connected to the Nth subhighway SHW_N and operates like the first time slot dividing unit 201_1.

The bit-synchronized PPP frame data separated on time slot basis at the first time slot dividing unit 201_1 are transferred to the first to the Mth valid data detecting unit 202_11 to 202_1M. That is, divided bit-synchronized PPP frame data transmitted through the first time slot are provided to the first valid data detecting unit 202_11 and those transferred through the Mth time slot are coupled to the Mth valid data detecting unit 202_1M. Bit-synchronized PPP frame data divided by the Nth time slot dividing unit 201_N are also supplied to the first to the Mth valid data detecting unit 202_N1 to 202_NM.

For instance, when each of the above subhighways is based on a 64 Kbps time slot, each of the time slot dividing units 201_1 to 201_N separates the bit-synchronized PPP frame data, transmitted via its corresponding subhighway, on a 64 Kbps basis.

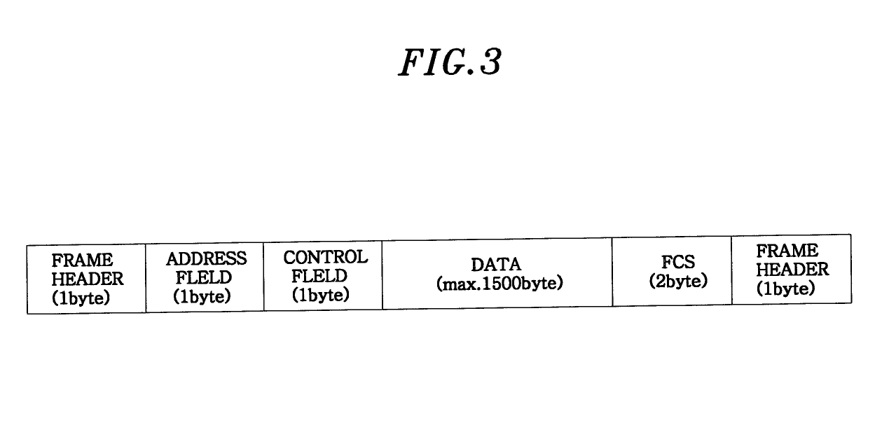

The first to the Mth valid data detecting unit 202_{—}k1 to 202_{—}kM detect whether or not the data supplied from their corresponding time slot dividing units are valid PPP frame data. As described with reference to FIG. 3, PPP frame data are configured with a frame header of 1 byte, an address field of 1 byte, a control field of 1 byte, a data region of maximum 1500 bytes, a frame check sequence (FCS) of 2 bytes and a frame header of 1 byte. It can be noticed from the above configuration that the PPP frame data are based on the HDLC format. The above frame headers are used in representing a starting point and an ending point of their corresponding PPP frame data and a value ‘0X7E’ is typically used to represent the frame headers.

Therefore, the above detection process is achieved by checking whether or not there exists the frame header of 1 byte (e.g., 0X7E) within the inputted data. For example, if there is 1 byte frame header information in the data transmitted via the first time slot of the first subhighway SHW_1 from the first time slot dividing unit 201_1, the first valid data detecting unit 202_11 detects and outputs the transmitted data as valid PPP frame data. Similarly, if the 1 byte frame header information is detected in the data transmitted via the Mth time slot of the first subhighway SHW_1 from the first time slot dividing unit 201_1, the Mth valid data detecting unit 202_1M detects and outputs the transmitted data as valid PPP frame data.

On the other hand, if there is no 1 byte frame header information detected on the transmitted data, the first to the Mth valid data detecting unit 202_11 to 202_1M detect that the transmitted data are not valid PPP frame data, and discard or neglect the transmitted data instead of transferring them to a next unit.

The valid PPP frame data concurrently outputted from the first to the Mth valid data detecting unit 202_{—}k1 to 202_{—}kM are provided to the first memory buffering unit 210.

The first memory buffering unit 210 detects on time slot basis whether the valid PPP frame data are coupled thereto or not, stores the valid PPP frame data and sequentially reads out the stored PPP frame data.

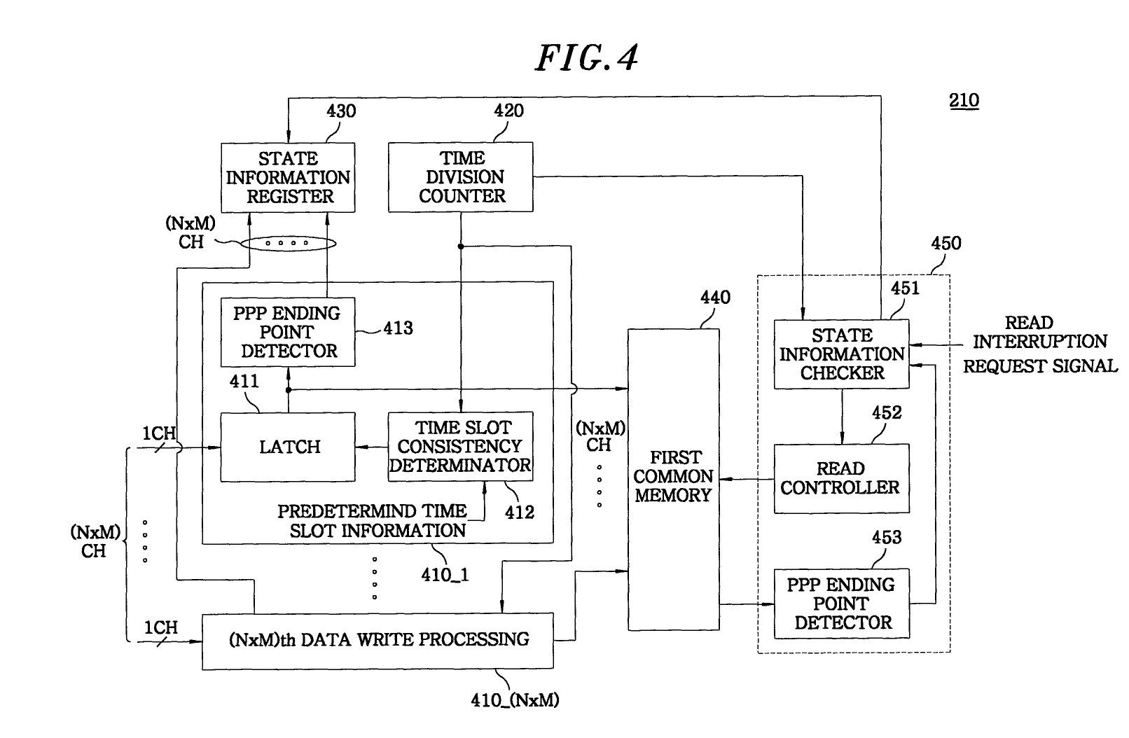

Referring to FIG. 4, there is provided a detailed block diagram of the first memory buffering unit 210 in FIG. 2.

The first memory buffering unit 210 includes a first to an (N×M)th data write processing block 410_1 to 410_(N×M), a time division counter 420 for controlling a writing mode of the N×M numbers of time slots corresponding to the subhighways SHW_1 to SHW_N during a one frame period and providing a time division counted value obtained by dividing the one frame period into N×M×2 intervals and assigning to each interval a corresponding time division counted value from 1 to N×M×2 to thereby alternately perform the writing mode and a reading mode during the one frame period, a state information register 430 for managing information representing a storage state of a first common memory 440 on time slot basis, the first common memory 440 for storing received valid PPP frame data on time slot basis and sequentially reading out the stored valid PPP frame data, and a data read processing block 450 for controlling the first common memory 440 to sequentially read out the stored valid PPP frame data.

Further, as shown in FIG. 4, each of the data write processing blocks 410_1 to 410_(N×M) contains a latch 411 connected to a corresponding valid data detecting unit among the N×M numbers of valid data detecting units 202_11 to 202_NM, a time slot consistency determinator 412 for detecting whether or not predetermined time slot information consists with the time division counted value provided from the time division counter 420, and a PPP ending point detector 413 for detecting frame header information representing an ending point from the PPP frame data outputted from the latch 411.

As described above, since there are N numbers of subhighways each of which includes M numbers of channels, there are N×M numbers of data write processing units 410_1 to 410_(N×M). Therefore, each of the data write processing units embodied in the first memory buffering unit 210 is assigned to a corresponding one of the time slots.

The latch 411 stores valid PPP frame data transmitted from its corresponding valid data detecting unit. That is, the latch of the first data write processing block 410_1 stores valid PPP frame data transferred from the valid data detecting unit 202_11 and that of the (N×M)th data write processing block 410 (N×M) stores valid PPP frame data delivered from the valid data detecting unit 202_NM. The valid PPP frame data stored in the latch 411 are outputted in response to a detection result of the time slot consistency determinator 412.

The time slot consistency determinator 412 detects whether or not the predetermined time slot information consists with the time division counted value provided from the time division counter 420 and supplies the detection result to the latch 411.

Namely, in case the one frame period for the N numbers of subhighways SHW_1 to SHW_N is 125 μs, the time division counter 420 divides the one frame period 125 μs into N×M×2 intervals and assigns to each interval a corresponding time division counted value from 1 to N×M×2, supplies the time division counted value to the first to the (N×M)th data write processing block 410_1 to 410_(N×M) and further provides the data read processing block 450 with a reading mode enable signal in response to the time division counted value, thereby alternately performing the writing mode and the reading mode during the one frame period.

The first memory buffering unit 210 generates the reading mode enable signal to the data read processing block 450 when the time division counted value is an even number, i.e., 0, 2, . . . On the other hand, when the time division counted value is an odd number, i.e., 1, 3, . . . , the first memory buffering unit 210 provides the counted result to the data write processing blocks 410_1 to 410_(N×M). Then, the time slot consistency determinator 412 judges whether or not the predetermined time slot information is identical with a counted value obtained by neglecting an LSB of the counted result provided from the time division counter 420.

For instance, if the predetermined time slot information is “1” and the counted value is “1”, the time slot consistency determinator 412 controls the latch 411 to sequentially output the stored valid PPP frame data. This means that the valid PPP frame data stored in the latch 411 are transferred to the first common memory 440 and stored in a storage of the first common memory 440 at a time given to a time slot (designated time) corresponding to the first data write processing block 410_1.

On the other hand, if the predetermined time slot information is not consistent with the counted value, the valid PPP frame data remain at the latch 411 until a next designated time. Therefore, the valid PPP frame data cannot be transferred to a corresponding storage in the first common memory 440 at the above designated time.

The PPP ending point detector 413 detects whether or not there are data representing an ending point among the valid PPP frame data delivered from the latch 411 to the first common memory 440. The data corresponding to the ending point is the frame header 0X7E of 1 byte located at an end of the data structure shown in FIG. 3. Accordingly, if the frame header of 1 byte is detected from the data outputted from the latch 411, the PPP ending point detector 413 recognizes that all of the valid PPP frame data stored in the latch 411 are provided to the first common memory 440.

Then, the PPP ending point detector 413 sets its corresponding flag of the state information register 430 to ‘1’ to thereby represent that the valid PPP frame data for its corresponding time slot are stored in the given storage of the first common memory 440. In accordance with another embodiment of the present invention, the PPP ending point detector 413 can be configured to set the flag to ‘0’ in the above case.

The state information register 430 is constructed to establish a flag for each time slot. Therefore, the state information register 430 has therein a region where N×M numbers of flag information can be established. As a result, if the ending point is detected at the PPP ending point detector 413 of the first data write processing block 410_1, the first flag of the state information register 430 is set to 1. In the meantime, if an ending point is detected at a PPP ending point detector of the (N×M)th data write processing block 410 (N×M), an (N×M)th flag of the state information register 430 is set to 1.

As the first to the (N×M)th data write processing block 410_1 to 410_(N×M) concurrently operate for a predetermined time, they deliver valid PPP frame data provided from corresponding valid data detecting units 202_11 to 202_NM to the first common memory 440.

The first common memory 440 has a fixed storage assigned to each time slot. That is, regardless of the size of the received PPP frame data, a storage having a preset size, e.g., 2048 bytes, is assigned to each frame. In accordance with this embodiment, the first common memory 440 contains N×M numbers of storages each of which has a same storage capacity. Accordingly, the valid PPP frame data coupled from the first data write processing block 410_1 are stored in the first storage of the first common memory 440 and those provided from the (N×M)th data write processing block 410_(N×M) are stored in the (N×M)th storage of the first common memory 440.

As described in FIG. 4, the data read processing block 450 has a state information checker 451, a read controller 452 and a PPP ending point detector 453, thereby sequentially reading out the valid PPP frame data stored in the first common memory 440 and then providing the valid PPP frame data to the PPP frame data transmitting unit 220 shown in FIG. 2.

More specifically, the state information checker 451 examines a state of a corresponding flag of the state information register 430 when a signal reporting a reading mode (or read enable signal) is coupled thereto with an active state from the time division counter 420. If the corresponding flag state is found to be ‘1’ in the examination, the state information checker 451 recognizes that the valid PPP frame data of a corresponding time slot are stored in the first common memory 440 and provides the read controller 451 with information related to the reading mode to thereby allow the PPP frame data of the corresponding time slot stored in the first common memory 440 to be read out.

That is to say, the state information checker 451 refers to the state information register 430 by using the time slot information currently contained therein if the read enable signal with the active state is coupled thereto from the time division counter 420. For example, if the current time slot information is ‘3’, the state information checker 451 examines the third flag of the state information register 430. If the third flag is found to represent an empty state, the state information checker 451 increases the time slot information contained therein by 1 without providing the information related to the reading mode to the read controller 452 since the examination result means that the valid PPP frame data corresponding to the time slot are not stored in the first common memory 440.

Then, if the read enable signal with the active state is fed thereto again from the time division counter 420, the state information checker 451 examines the fourth flag of the state information register 430. The signal reporting the reading mode with the active state is provided when none of the first to the (N×M)th data write processing block 410_1 to 410_(N×M) execute a writing mode. As a result, the writing mode and the reading mode are alternately performed at the first memory buffering unit 210.

As can be seen from the operation of the state information checker 451, the time slot information contained in the state information checker 451 is updated according to a scheme of increasing the time slot information by 1 from the first time slot of the first subhighway SHW_1. When the reading mode for the (N×M)th time slot is completed, the current time slot information of the state information checker 451 is updated by the first time slot information of the first subhighway SHW_1. This means that the reading mode for the first common memory 440 is sequentially executed for each time slot.

As a result of referring to the state information register 430, if the flag state of the corresponding time slot is ‘1’, the state information checker 451 provides the read controller 452 with information related to the reading mode such as the read control enable signal and an address of the corresponding storage.

When the state information checker 451 operates as described above, if a read interruption request signal is inputted from the data converting unit 230, the state information checker 451 first delivers the read interruption request signal to the read controller 452 which, in turn, disables the reading mode. After then, if the read interruption request signal is cleared, the state information checker 451 generates a reading mode enable signal to the read controller 452 which, in response to the reading mode enable signal, controls the reading mode for the first common memory 440 to sequentially read out the PPP frame data restarting from the interruption point.

The PPP ending point detector 453 has the same constitution as the PPP ending point detector 413 and detects whether or not data representing the ending point (the 1 byte frame header data located at the end of the data structure shown in FIG. 3) exist in the valid PPP frame data read out from the first common memory 440. If the data representing the ending point are detected, the PPP ending point detector 453 reports the data detection to the state information checker 451. Then, the state information checker 451 sets the flag of the state information register 430 corresponding to the time slot contained therein to an empty state ‘0’ and increases the time slot information by 1. As a result, the state information register 430 registers information representing that the storage of the first common memory 440 corresponding to the corresponding time slot is in the empty state.

The valid PPP frame data sequentially read out on the frame basis from the first common memory 440 are provided to the PPP frame data transmitting unit 220 which then transfers the received data to the data converting unit 230 through a serial line.

If the valid PPP frame data are inputted thereto in series, the data converting unit 230 produces converted PPP frame data including therein routing information to thereby make the MSM (not shown) perform in itself a high-speed real-time routing based on the converted PPP frame data on the frame basis.

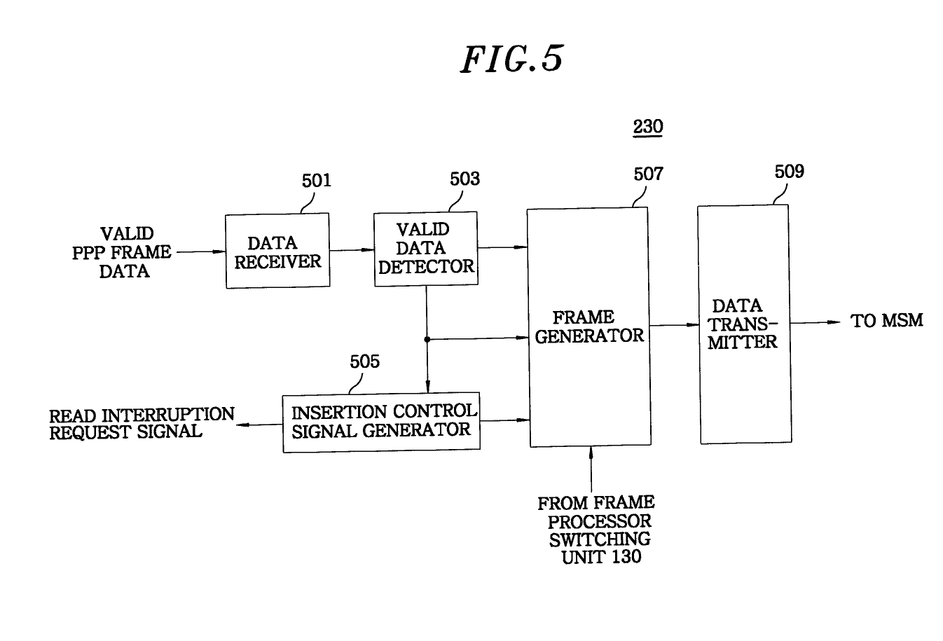

As shown in FIG. 5, for performing the above operation, the data converting unit 230 has a data receiver 501, a valid data detector 503, an insertion control signal generator 505, a frame generator 507 and a data transmitter 509.

The data receiver 501 receives the valid PPP frame data transmitted in series from the PPP frame data transmitting unit 220 and transfers the received data to the valid data detector 503. The valid data detector 503 detects whether valid PPP frame data are received or not by checking if there exists the frame header information 0X7E in the transmitted data as in the valid data detecting units in FIG. 2. As a checking result, if the frame header information is detected, the valid data detector 503 reports the detection of the frame header representing a starting point of the valid PPP frame data to the insertion control signal generator 505 and the frame generator 507, and provides the valid PPP frame data to the frame generator 507 in series.

If the detection of the frame header is reported thereto from the valid data detector 503, the insertion control signal generator 505 produces an insertion request signal for routing information to the frame generator 507 while providing the read interruption request signal to the first memory buffering unit 210. In response to the read interruption request signal, the data read processing block 450 of the first memory buffering unit 210 stops the operation of reading out the valid PPP frame data from the first common memory 440 as depicted above and the frame generator 507 inserts corresponding routing information into the valid PPP frame data provided thereto from the valid data detector 503.

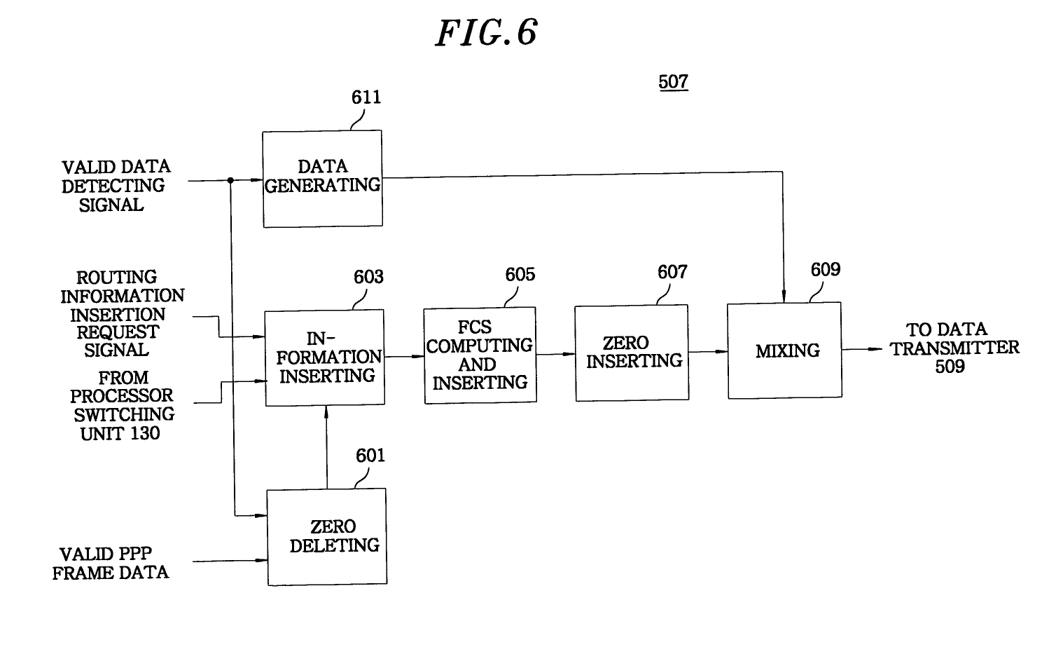

As illustrated in FIG. 6, for inserting the routing information into the received valid PPP frame data, the frame generator 507 contains a zero deleting block 601, an information inserting block 603 for inserting the routing information, an FCS computing and inserting block 605, a zero inserting block 607, a mixing block 609 and a data generating block 611.

If a valid data detecting signal is provided from the valid data detector 503, the zero deleting block 601 conducts a zero deleting process for the valid PPP frame data transmitted in series from the valid data detector 503. When the received data have a bit of ‘0’ following 5 consecutive bits of ‘1’, the zero deleting process is performed by deleting the bit of ‘0’. The zero deleted valid PPP frame data are supplied to the information inserting block 603.

If a routing information insertion request signal is coupled thereto from the insertion control signal generator 505, the information inserting block 603 reads out the routing information including a destination address and a source address stored in the control memory 131 of the processor switching unit 130. The destination address represents information for an output point of the MSM and the source address shows information including identifiers (IDs) of the corresponding time slot and the PPP frame data line-concentrating and distributing apparatus.

The source address contains the ID of the PPP frame data line-concentrating and distributing apparatus since a plurality of PPP frame data line-concentrating and distributing apparatuses can exist in a front-end of the MSM as shown in FIG. 1. In case the plurality of PPP frame data line-concentrating and distributing apparatuses are located in the front-end of the MSM, the processor switching unit 130 can be employed in each apparatus or commonly used by the apparatuses each of which comprises only the PPP frame data line-concentrating unit 110 and the distributing unit 120. When the processor switching unit 130 is employed in each apparatus, the control memory 131 stores one destination address, one apparatus ID and N×M numbers of time slot information. On the other hand, if the processor switching unit 130 is commonly used by the plurality of apparatuses, the above information should be prepared and stored for each apparatus located in the front-end of the MSM.

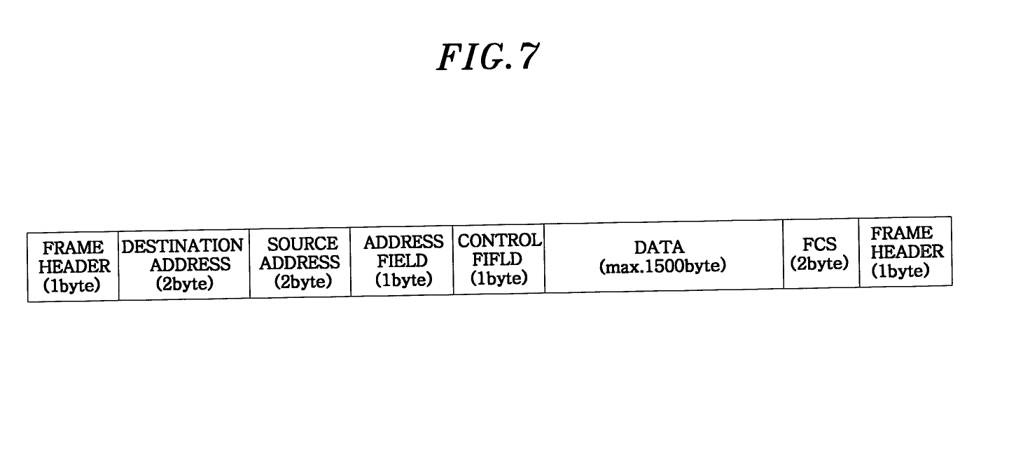

If the destination address and the source address are provided thereto from the control memory 131 and the zero deleted valid PPP frame data are fed thereto from the zero deleting block 601, as described in FIG. 7, the information inserting block 603 inserts the destination address and the source address in sequence between the region containing thereon frame header information representing a starting point and the address field.

Referring to FIG. 7, the destination address is inserted into a region of 2 bytes following the region containing thereon the frame header information and the source address is inserted into a next region of 2 bytes. However, in the above, the amount of data of the regions into which the destination address and the source address are inserted is not necessarily fixed as 2 bytes.

The PPP frame data, which contains the destination address and the source address therein, shown in FIG. 7 are transferred to the FCS computing and inserting block 605.

The FCS computing and inserting block 605 ciphers FCS of the PPP frame data transferred from the information inserting block 603 on a bit basis and inserts the FCS into a region of 2 bytes in front of the frame header representing the ending point as described in FIG. 7.

The valid PPP frame data provided to the FCS computing and inserting block 605 includes FCS information inserted when the valid PPP frame data are transmitted via the corresponding time slot and, therefore, the FCS information is also used in the FCS computing process. The PPP frame data including the FCS information therein are fed to the zero inserting block 607.

The zero inserting block 607 processes the data provided thereto through an inverse operation of the zero deleting block 601. That is, if the data includes 5 consecutive bits of ‘1’, the zero inserting block 607 inserts ‘0’ into a bit following the 5 consecutive bits. The zero inserted PPP frame data are supplied to the data transmitter 509 via the mixing block 609.

The mixing block 609 provides the data transmitter 509 with the PPP frame data outputted from the zero inserting block 607 or specific data (e.g., 0XFF) outputted from the data generating block 611 as the converted PPP frame data.

The data generating block 611 is disabled in response to the valid data detecting signal with an active state and does not output the 0XFF data. On the other hand, if the valid data detecting signal with an inactive state is coupled thereto, the data generating block 611 is enabled to produce the 0XFF data on a byte basis.

The inactive state of the valid data detecting signal generated from the valid data detector 503 is set when a frame header denoting a starting point of next valid PPP frame data is not detected after the frame header representing the ending point of the current valid PPP frame data is detected, and remains in the inactive state until the frame header standing for the starting point of the next valid PPP frame data is detected. The 0XFF data can be embodied on the data provided to the data transmitter 509 when there is no PPP frame data stored in the first common memory 440 and this means that Internet calls are hardly established.

Referring back to FIG. 5, the data transmitter 509 transmits the converted PPP frame data supplied from the frame generator 507 in the form of a packet to the MSM. The MSM self-routes the transmitted PPP frame data with reference to the information contained in the destination address region of the transmitted PPP frame data and outputs the PPP frame data via a corresponding output terminal thereof.

Meanwhile, the PPP frame data distributing unit 120 described in FIG. 1 distributes the inputted PPP frame data on a PPP frame basis to thereby transmit the PPP frame data through a pertinent time slot of a corresponding subhighway.

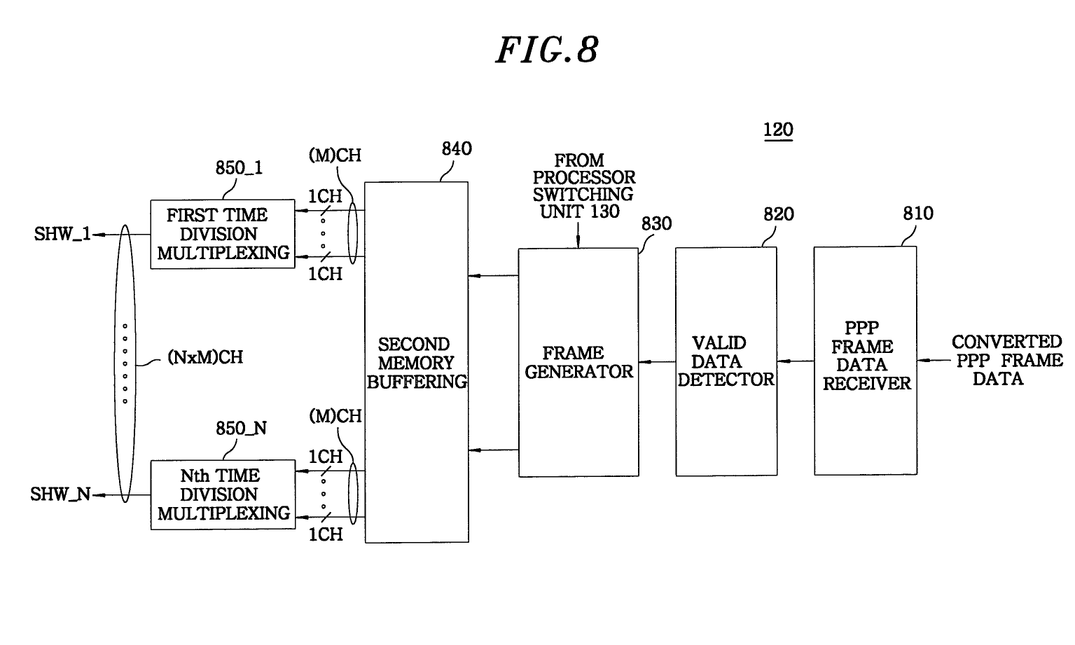

Referring to FIG. 8, there is illustrated a detailed block diagram of the PPP frame data distributing unit 120, which includes a PPP frame data receiver 810, a valid data detector 820, a frame generator 830, a second memory buffering unit 840 and a first to an Nth time division multiplexing unit 850_1 to 850_N.

The PPP frame data receiver 810 processes the converted PPP frame data provided thereto from the MSM through an inverse operation of the data transmitter 509 in FIG. 5. The converted PPP frame data have the same structure as shown in FIG. 7. That is, the destination address region contains an ID of a corresponding PPP frame data line-concentrating and distributing apparatus and the source address region holds corresponding time slot information. The converted PPP frame data processed by the PPP frame data receiver 810 are then transferred to the valid data detector 820.

If the PPP frame data are fed thereto, the valid data detector 820 detects whether valid PPP frame data are received or not in the same manner as used in the valid data detector 503 in FIG. 5. Namely, the valid data detector 820 checks whether or not the received data have the frame header 0X7E denoting its starting point. If the received data does not have the frame header 0X7E, then the valid data detector 820 does not transmit the received data to a next circuit. On the other hand, if the frame header is detected, the valid data detector 820 provides the frame generator 830 with the received PPP frame data together with a valid data detecting signal.

The frame generator 830 reconstructs the original PPP frame data structure transmitted through the time slot based on the PPP frame data provided from the valid data detector 820.

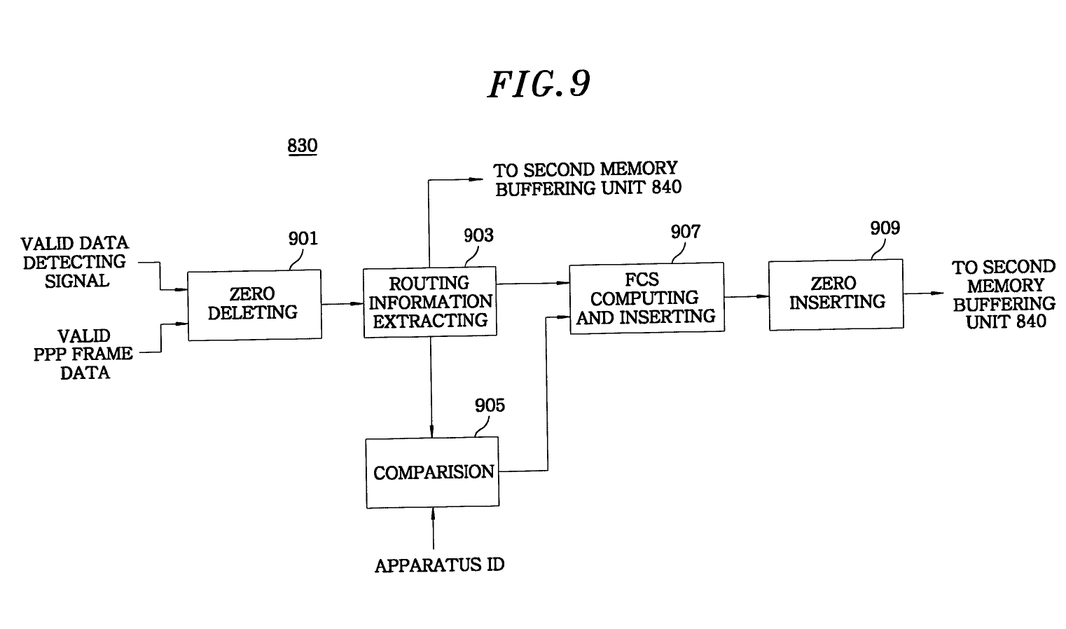

In FIG. 9, there is shown a detailed block diagram of the frame generator 830, which has a zero deleting block 901, a routing information extracting block 903, a comparison block 905, an FCS computing and inserting block 907 and a zero inserting block 909.

If the valid data detecting signal and the valid PPP frame data are provided thereto from the valid data detector 820, the zero deleting block 901 performs a zero deleting process for the valid PPP frame data. The zero deleting process is executed in the same manner as used in the zero deleting block 601. The zero deleted PPP frame data are delivered to the routing information extracting block 903.

Since the PPP frame data have the data structure as depicted in FIG. 7, the routing information extracting block 903 extracts time slot information transmitted through the destination address region and the source address region. A destination address extracted from the destination address region is provided to the comparison block 905, whereas time slot information extracted from the source address region is coupled to the second memory buffering unit 840.

The comparison block 905 contains an apparatus ID, supplied in an initialization from the processor switching unit 130, as a reference value and checks if the apparatus ID is identical with the destination address transmitted from the routing information extracting block 903. As afore-mentioned, since the plurality of PPP frame data line-concentrating and distributing apparatuses can be connected to the MSM, a higher processor (not shown) assigns an apparatus ID to each of the PPP frame data line-concentrating and distributing apparatuses. The assigned apparatus ID is stored in the control memory 131 of the processor switching unit 130 and supplied to its corresponding PPP frame data line-concentrating unit 110 and PPP frame data distributing unit 120.

As a result of the comparison process performed at the comparison block 905, if it is determined that the extracted destination address is not identical with the apparatus ID, the comparison block 905 disables the FCS computing and inserting block 907 so as not to transmit the received PPP frame data to a next block. On the other hand, if the extracted destination address is identical to the apparatus ID, the comparison block 905 enables the FCS computing and inserting block 907.

The enabled FCS computing and inserting block 907 ciphers FCS for the PPP frame data transmitted from the routing information extracting block 903. At this time, the transmitted PPP frame data have the same structure as shown in FIG. 3 that does not include data pertinent to the destination address and the source address. If the computation of the FCS is completed, the computed FCS value is inserted into the FCS region of the PPP frame data having the structure depicted in FIG. 3.

The PPP frame data including the computed FCS value are delivered to the zero inserting block 909. The zero inserting block 909 inserts ‘0’ into the delivered PPP frame data in the same manner as in the zero inserting block 607 in FIG. 6 and conveys the zero inserted PPP frame data to the second memory buffering unit 840 in FIG. 8.

Referring back to FIG. 8, if the PPP frame data having the structure shown in FIG. 3 are provided thereto from the frame generator 830, the second memory buffering unit 840 performs the time division process for the PPP frame data according to the providing sequence, stores the time-divided PPP frame data and concurrently accesses the stored PPP frame data so as to read out the stored PPP frame data at a preset time on time slot basis of the subhighways.

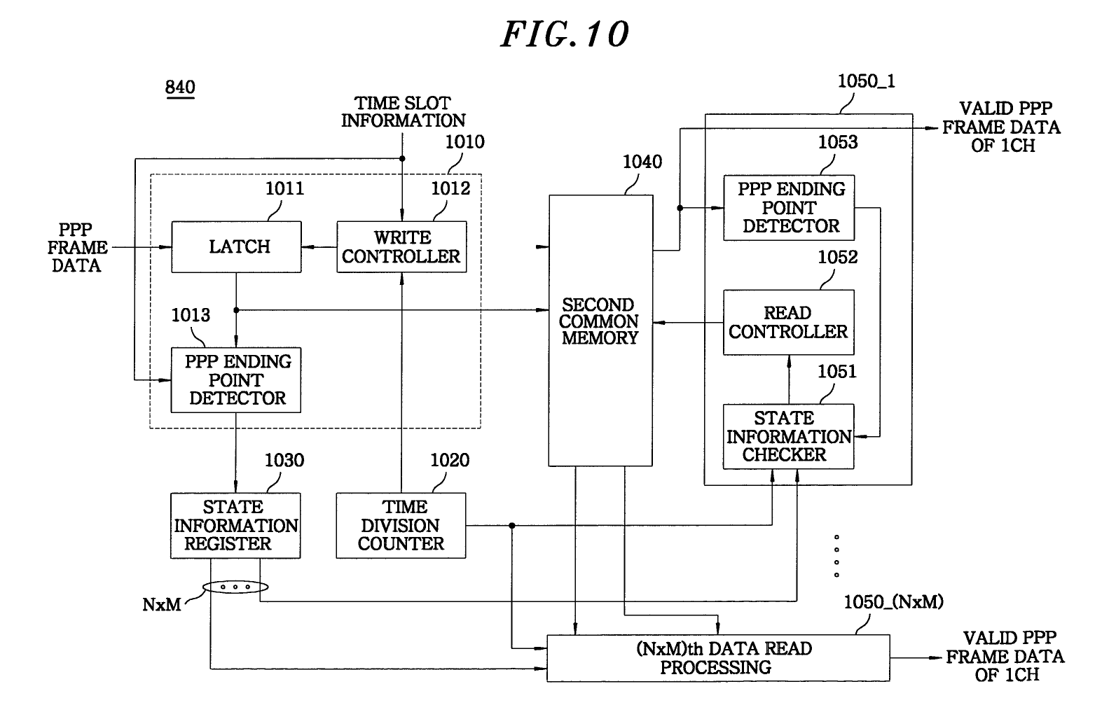

Referring to FIG. 10, there is provided a detailed block diagram of the second memory buffering unit 840, which has a data write processing block 1010, a time division counter 1020, a state information register 1030, a second common memory 1040 and a first to an (N×M)th data read processing block 1050_1 to 1050_(N×M).

The data write processing block 1010 contains a latch 1011, a write controller 1012 and a PPP ending point detector 1013, and stores the PPP frame data transmitted from the frame generator 830 in a storage of the second common memory 1040.

That is, the latch 1011 sequentially stores therein the valid PPP frame data transmitted from the frame generator 830.

If writing mode range information with an active state is provided thereto from the time division counter 1020, the write controller 1012 enables the latch 1011 to generate a write address to the second common memory 1040 based on the time slot information supplied from the frame generator 830.

The time division counter 1020 operates like the time division counter 420 described with reference to FIG. 4. However, the counted result provided from the time division counter 1020 to the data write processing block 1010 is a signal reporting a writing mode.

If the latch 1011 is enabled by the write controller 1012, it provides the valid PPP frame data stored therein to the second common memory 1040. The second common memory 1040 stores the PPP frame data supplied from the latch 1011 in a storage corresponding to the write address coupled from the write controller 1020. Accordingly, the writing mode for the second common memory 1040 is randomly performed at intervals determined by dividing 125 μs by N×M. The storages of the second common memory 1040 are divided by N×M and a storage capacity of each of the divided storages is identical to each other.

Like the PPP encoding point detectors 413 and 453 in FIG. 4, the PPP ending point detector 1013 checks whether or not the frame header representing the ending point is detected from the PPP frame data outputted from the latch 1011. As a checking result, if the frame header is detected, it means that the writing mode for the corresponding PPP frame data is completed. Accordingly, the PPP ending point detector 1013 sets a corresponding flag of the state information register 1030 to ‘1’ with reference to the time slot information provided from the frame generator 830. In accordance with another embodiment of the present invention, the flag of the state information register 1030 can be set to ‘0’. The configuration of the state information register 1030 is identical with that of the state information register 430 shown in FIG. 4.

The first data read processing block 1050_1 processes the valid PPP frame data stored in the corresponding storage of the second common memory 1040 to be read out based on the counted value from the time division counter 1020 and flag information of a corresponding time slot stored in the state information register 1030. Herein, the time division counter 1020 divides one frame period of the N numbers of subhighways by N×M×2.

For performing the above operation, the first data read processing block 1050_1 contains a state information checker 1051, a read controller 1052 and a PPP ending point detector 1053. If the counted value provided from the time division counter 1020 is consistent with predetermined time slot information, the state information checker 1051 refers to the corresponding flag information of the state information register 1030. The corresponding flag information is flag information assigned to the first time slot among the N×M numbers of flag information stored in the state information register 1030. The predetermined time slot information is determined in advance as in the time slot consistency determinator 412 in FIG. 4.

If the flag information has ‘1’, it means that valid PPP frame data are stored in the corresponding storage of the second common memory 1040, so that the state information checker 1051 provides a reading mode enable signal to the read controller 1052. The corresponding storage of the second common memory 1040 is a storage pertinent to the first time slot among the N×M numbers of time slots.

If the reading mode enable signal is inputted thereto from the state information checker 1051, the read controller 1052 accesses the corresponding storage of the second common memory 1040 to read out the valid PPP frame data stored in the storage. The valid PPP frame data read out from the second common memory 1040 are coupled to the first time division multiplexing unit 850_1 in FIG. 8.

Under the control of the read controller 1052, the PPP ending point detector 1053 finds out an ending point from the PPP frame data outputted from the second common memory 1040. If the ending point is detected, the PPP ending point detector 1053 reports the detection of the ending point to the state information checker 1051. Then, the state information checker 1051 sends a reading mode disable signal to the read controller 1052 to thereby stop performing the reading mode for the second common memory 1040. Further, the state information checker 1051 examines whether the predetermined time slot information is identical to the counted value provided from the time division counter 1020.

The second to the (N×M)th data read processing block 1050_2 to 1050_(N×M) operate like the first data read processing block 1050_1 and, as a result, provide their corresponding valid PPP frame data read out from the second common memory 1040 to the first to the Nth time division multiplexing unit 850_1 to 850_N.

As described with reference to FIG. 8, since each of the first to the Nth time division multiplexing unit 850_1 to 850_N is assigned to one of the subhighways, each time division multiplexing unit is connected to M numbers of data read processing blocks among the first to the (N×M)th data read processing block 1050_1 to 1050_(N×M). For instance, the first time division multiplexing unit 850_1 is configured to receive the PPP frame data outputted under the control of the first to the Mth data read processing blocks among the data read processing blocks embodied in the second memory buffering unit 840. The above PPP frame data are outputted in a corresponding interval among the intervals determined by dividing 125 μs by the number N×M. For example, the PPP frame data outputted under the control of the first data read processing block 1050_1 are transmitted during the first interval.

If the valid PPP frame data are fed thereto on time slot basis from the second memory buffering unit 840, each of the first to the Nth time division multiplexing unit 850_1 to 850_N multiplexes the inputted valid PPP frame data according to the intervals to thereby transfer the valid PPP frame data through its corresponding subhighway. The PPP frame data transmitted through its corresponding channel of the subhighway are supplied to a corresponding subscriber terminal (not shown).

As described above, the present invention provides the apparatus for line-concentrating and distributing PPP frame data which are transmitted between the subhighways capable of transmitting bit-synchronized PPP frame data and being embodied in an access switch subsystem and the MSM to be embodied in the Internet gateway unit, so that there can be obtained advantages such as maximizing the functions of the MSM and the subhighways, and enhancing the quality of Internet services. For instance, in the line-concentrating and distributing process, it can be expected to provide high-speed services by detecting and transmitting only valid PPP frame data.

Further, in the line-concentrating process, the present invention inserts a destination address and source address into the PPP frame data to be transmitted to thereby perform a high-speed real-time routing in the MSM, wherein the inserting process is carried out by storing information provided only once from a higher processor in the control memory of the processor switching unit and then reading out the stored information when the information is required to be inserted into the PPP frame data. As a result, the present invention can reduce a load of the higher processor due to the self-routing of the MSM.

While the present invention has been described with respect to the particular embodiments, it will be apparent to those skilled in the art that various changes and modifications may be made without departing from the spirit and scope of the invention as defined in the following claims.

What is claimed is:

1. An apparatus for transmitting bit-synchronized PPP frame data between N numbers of subhighways (SHWs), embodied in an access switch subsystem of a switch, capable of transmitting the bit-synchronized PPP frame data which have a high-level data link control (HDLC) format and are generated to process Internet calls, N being a predetermined integer, and a message switch module (MSM), embodied in an Internet gateway unit implemented for switching between Internet and the switch, for routing and transmitting the bit-synchronized PPP frame data, which comprises:
a line-concentrating unit for, if the bit-synchronized PPP frame data are provided through M numbers of time slots included in each of the subhighways, M being a predetermined integer, extracting and storing valid bit-synchronized PPP frame data on time slot basis, sequentially reading out the stored valid bit-synchronized PPP frame data to thereby produce line-concentrated PPP frame data, and transmitting the line-concentrated PPP frame data to the MSM; and
a distributing unit for, if the line-concentrated PPP frame data are provided from the MSM, extracting valid PPP frame data, sequentially storing the extracted valid PPP frame data, concurrently reading out the stored valid PPP frame data on time slot basis and transferring the read-out valid PPP frame data through a corresponding time slot of a pertinent subhighway.

2. The apparatus as recited in claim 1, wherein the line-concentrating unit includes:
N numbers of time slot dividing blocks each of which is assigned to said each of the subhighways and divides the bit-synchronized PPP frame data transferred through a corresponding subhighway on time slot basis to thereby output divided data;
N×M numbers of valid data detecting blocks for checking whether the divided data are the valid bit-synchronized PPP frame data or not, wherein each set of M numbers of valid data detecting blocks is assigned to said each of the time slot dividing blocks; and
a memory buffering block for storing the valid bit-synchronized PPP frame data transmitted from each of the valid data detecting blocks for a predetermined time, and reading out the stored valid bit-synchronized PPP frame data to thereby output the line-concentrated PPP frame data.

3. The apparatus as recited in claim 2, wherein the memory buffering block contains:
a common memory for storing the valid bit-synchronized PPP frame data on time slot basis;
a state information register for managing information representing a storage state of the common memory on time slot basis;
a time division counter for controlling a writing mode for the common memory so as to process N×M numbers of time slots for a one frame period assigned to the N numbers of subhighways, and performing a time division counting for the one frame period in order to alternately carry out the writing mode and a reading mode for the common memory;
N×M numbers of write processing blocks for, if the bit-synchronized PPP frame data are provided thereto from the valid data detecting blocks, storing the bit-synchronized PPP frame data in a designated storage at a given time in response to the time division counted result, and updating flag information contained in the state information register, wherein the write processing blocks cope one-to-one with the valid data detecting blocks; and
a read processing block for controlling the reading mode for the common memory to sequentially output the valid bit-synchronized PPP frame data stored in the common memory with reference to the flag information stored in the state information register during a period in which a reading mode enable signal is supplied from the time division counter.

4. The apparatus as recited in claim 3, wherein each of the write processing blocks has:
a consistency determinator for deciding whether or not the time division counted result is identical to predetermined time slot information;
a latch for storing the bit-synchronized PPP frame data supplied from a corresponding valid data detecting block and outputting the stored bit-synchronized PPP frame data when it is determined that the time division counted result is identical to the predetermined time slot information; and
an ending point detector for updating corresponding flag information stored in the state information register when data representing an ending point are detected in the bit-synchronized PPP frame data outputted from the latch.

5. The apparatus as recited in claim 4, wherein the read processing block has:
a read controller for providing the common memory with a reading mode establishing signal and a corresponding address;
an ending point detector for detecting an ending point from the bit-synchronized PPP frame data outputted from the common memory; and
a state information checker for providing the read controller with information used in controlling the reading mode of a storage of the common memory where the bit-synchronized PPP frame data are stored as sequentially referring to the flag information contained in the state information register if the reading mode enable signal is coupled from the time division counter, setting a region of the state information register corresponding to said storage of the common memory to an empty state if the ending point is detected by the ending point detector, and increasing time slot information contained therein by 1.

6. The apparatus as recited in claim 1, wherein the distributing unit includes:
a valid data detecting block for checking whether or not the PPP frame data delivered from the MSM are valid data and, in response to the checking result, generating a valid data detecting signal;
a frame generating block for converting the PPP frame data into a form capable of being transmitted through the time slots when the valid data detecting signal is inputted thereto from the valid data detecting block;
a memory buffering block for sequentially storing the converted PPP frame data provided from the frame generating block in designated storages therein and performing a reading process for the stored PPP frame data in a predetermined time on time slot basis; and
N numbers of time division multiplexing blocks for performing time division multiplexing for the PPP frame data outputted from the memory buffering block so as to transmit the multiplexed PPP frame data through the corresponding time slot of the pertinent subhighway.

7. The apparatus as recited in claim 6, wherein the frame generating block contains:
a zero deleting block for performing a zero deletion process for the PPP frame data delivered with the valid data detecting signal from the valid data detecting block, thereby generating zero deleted PPP frame data;
a routing information extracting block for extracting routing information from the zero deleted PPP frame data to thereby generate routing information deleted PPP frame data;
a comparison block for checking whether destination information obtained from the extracted routing information is identical to apparatus identification (ID) information prestored therein;
a frame check sequence (FCS) computing and inserting block for, if the destination information is determined identical to the prestored apparatus ID information, ciphering a FCS of the routing information deleted PPP frame data and inserting the computed FCS into the routing information deleted PPP frame data to thereby produce FCS inserted PPP frame data; and
a zero inserting block for performing a zero inserting process for the FCS inserted PPP frame data.

8. The apparatus as recited in claim 7, wherein the memory buffering block contains:
a common memory for storing the converted PPP frame data on time slot basis;
a state information register for managing information representing a storage state of the common memory on time slot basis;
a time division counter for controlling a reading mode for the common memory so as to process the N×M numbers of time slots for a one frame period assigned to the N numbers of subhighways, and performing a time division counting for the one frame period in order to alternately carry out the reading mode and a writing mode for the common memory;
a write processing block for controlling the common memory to write the converted PPP frame data in designated storages during a period in which a writing mode enable signal is supplied from the time division counter; and
N×M numbers of read processing blocks for, if it is determined that there exists PPP frame data in a certain storage of the common memory as a result of checking the state information register at a given time in response to the time division counted result, reading out the existing PPP frame data, wherein the reading process for the common memory is performed on time slot basis.

9. The apparatus as recited in claim 8, wherein the write processing block has:
a latch for storing the converted PPP frame data;
a write controller for controlling the writing mode of the common memory by using time slot information provided from the frame generating block as well as controlling the latch to output the converted PPP frame data stored in the latch; and
an ending point detector for detecting whether or not there exist data representing an ending point in the PPP frame data outputted from the latch and, if the ending point is detected, establishing a flag pertinent to the time slot information, which is stored in the state information register.

10. The apparatus as recited in claim 8, wherein each of the read processing blocks has:
a read controller for controlling the reading mode of the common memory;
an ending point detector for detecting an ending point from the PPP frame data outputted from the common memory; and
a state information checker for providing the read controller with information related to the reading mode if it is determined that there exists the PPP frame data in the common memory as a result of checking a state of the flag stored in the state information register when the time division counted value is identical to prestored time slot information, making a region corresponding to said flag of the state information register an empty state if the ending point detection is reported from the ending point detector.

11. The apparatus as recited in claim 1, wherein the line-concentrating unit further includes a function of inserting routing information into the line-concentrated PPP frame data and transmitting the routing information inserted PPP frame data to the MSM that self-routes the routing information inserted PPP frame data.

12. The apparatus as recited in claim 11, wherein the line-concentrating unit produces the routing information which includes a destination address indicating an output terminal of the MSM and a source address having apparatus identification (ID) information assigned to the line-concentrating unit and time slot information through which the bit-synchronized PPP frame data are transmitted, wherein the routing information is inserted into a region following a frame header representing a starting point of the line-concentrated PPP frame data provided to the MSM.

13. The apparatus as recited in claim 12 further comprises:
a processor switching unit for storing the routing information supplied from a higher processor of the access switch subsystem in a system initialization and providing the routing information to the line-concentrating unit when the line-concentrating unit requires the routing information as the frame header representing the starting point is detected from the line-concentrated PPP frame data.

14. The apparatus as recited in claim 13, wherein the line-concentrating unit includes a data converting block which contains a detector for detecting the frame header representing the staring point if the line-concentrated PPP frame data are inputted, and a frame generator for reading out the routing information from the processor switching unit if the frame header is detected and inserting the routing information into the region following the frame header of the PPP frame data transmitted from the detector.

15. The apparatus as recited in claim 14, wherein the data converting block further contains:
an insertion control signal generating block for generating a routing information insertion request signal to the frame generator and a read interruption request signal to the memory buffering block when it is reported that the frame header representing the starting point is detected at the detector, thereby preventing the PPP frame data from being transmitted from the memory buffering block to the data converting block.

16. The apparatus as recited in claim 15, wherein the frame generator has:
a zero deleting block for performing a zero deletion process for the PPP frame data coupled thereto if it is reported that the frame header representing the staring point is detected at the detector, thereby producing zero deleted PPP frame data;
a routing information inserting block for reading out corresponding routing information from the processor switching unit and inserting the routing information into the zero deleted PPP frame data if the routing information insertion request signal is fed thereto from the insertion control signal generating block, thereby generating routing information inserted PPP frame data;
a frame check sequence (FCS) computing and inserting block for ciphering an FCS of the routing information inserted PPP frame data and inserting the computed FCS into the routing information inserted PPP frame data to thereby produce FCS inserted PPP frame data; and
a zero inserting block for performing a zero inserting process for the FCS inserted PPP frame data.

17. The apparatus as recited in claim 16, wherein the frame generator further has:
a data generating block for producing specific data if the starting point detection is not reported thereto; and
a mixing block for combining the specific data and the zero inserted PPP frame data and transmitting the combined data to the MSM.
